(19) United States
(12) Patent Application Publication
(10) Pub. No.: US 2013/0322097 A1
(43) Pub. Date: Dec. 5, 2013

(54) TORCHIERE STYLE LAMP HAVING KNOCK-DOWN PROFILE

(71) Applicant: Lee Schaak, Dix Hills, NY (US)

(72) Inventor: Lee Schaak, Dix Hills, NY (US)

(73) Assignee: Adesso Inc., New York, NY (US)

(21) Appl. No.: 13/488,599

(22) Filed: Jun. 5, 2012

(51) Int. Cl. F21S 8/08

(52) U.S. Cl. 362/414

(57) ABSTRACT

In accordance with one embodiment, a torchiere style lamp having a knock down profile includes a base; a pole attached at a bottom end to the base; and a socket assembly attached to a top end of the pole. The lamp also includes a torchiere style shade formed of a flexible material and including a slit that defines separate first and second shade edges. Wherein in a knock down condition, the shade has a rolled up construction and the shade assumes a fully assembled condition when the first and second edges are joined to one another along the first and second shade edges to form a shade that is open along its top and bottom. The shade is coupled to the socket assembly being disposed between a center hub and a main socket part of the socket assembly that surrounds and extends radially outward from the center electrical socket member.

### TECHNICAL FIELD

The present invention relates to lighting implements and in particular, relates to a torchiere style lamp having a knock-down profile to permit less packaging to be needed and increase ease of storage and transportation.

### BACKGROUND

There are many different types of products that provide light including natural products, such as candles, and electric or gas powered lights as has become convention.

Within the technical field of electric lights, there are a vast number of different products based on the style of the product, such as a desk lamp, floor lamp, or fixed lighting, and also based on the light producing means, including fluorescent bulbs, gas-discharge bulbs, incandescent bulb, LED bulbs, etc.

One type of popular floor lamp is a torchiere or torch lamp. A torchiere is a lamp with a tall stand and originally, torchieres were candelabra and included two or three lights. Today, torchiere lamps use fluorescent or halogen light bulbs. Torchiere lamps usually include a dimmer switch to allow the lamp's light output to be varied as by turning a knob along the stand. The knob also acts as the on-off switch. The torchiere design is marked by its tall stature with placement of the light source (bulb) at the very top of the stand (pole).

Many torchiere lamps have a metal bowl-shaped or frustoconical shaped shade structure in which the light bulb seats. As mentioned, this structure is located at the top of the pole (stand) of the lamp.

Due to the popularity of these types of lamps, there is a need to provide a more economical way of packaging such a product. The size of the pole (stand) and the metal lamp shade structure present a challenge in terms of packaging the product in the smallest space.

### SUMMARY

In accordance with one embodiment, a torchiere style lamp having a knock down profile includes a base; a pole attached at a bottom end to the base; and a socket assembly attached to a top end of the pole. The socket assembly includes a center electrical socket member that is operatively connected to a power cord that is routed through the pole and out of the base and is constructed to receive a bulb. The lamp also includes a torchiere style shade that is removably attached to the socket. The shade is formed of a flexible material and includes a slit formed therein from a bottom edge thereof to a top edge thereof so as to define separate first and second shade edges. Wherein in a knock down condition, the shade has a rolled up construction and the shade assumes a fully assembled condition when the first and second edges are joined to one another along the first and second shade edges to form a shade that is open along its top and bottom.

The shade is coupled to the socket assembly being disposed between a center hub and a main socket part of the socket assembly that surrounds and extends radially outward from the center electrical socket member.

It will be appreciated that by constructing all of the major components of the lamp 100 to have a knock-down construction, all of the parts of the lamp 100 can be conveniently packaged in a minimal amount of packing space. This allows the carton 10 or the like that is used to have a small footprint. This reduces not only packaging costs but also yields improvements in storage and transportation since the carton 10 occupies less space and more cartons can be placed on a pallet, etc., more can be placed on a retail shelf, etc.

### BRIEF DESCRIPTION OF THE DRAWING FIGURES

FIG. 1 is a perspective view of a torchiere style lamp in accordance with the present invention is an assembled condition;

FIG. 2 is a perspective view, in partial breakaway, showing individual components of the torchiere lamp in a shipping package;

FIG. 3 is a perspective view of the components in knock-down form shown exploded from the packaging;

FIG. 4 is an exploded perspective view of a lamp base with legs shown exploded therefrom taken at arrow 4 of FIG. 1;

FIG. 5 is a perspective view of a lamp shape in a pre-formed condition suitable for shipping;

FIG. 5a is a perspective close-up view of a section of the lamp shade that receives the fastener;

FIG. 6 is an exploded perspective view of the lamp shade adjacent a lamp head component showing a conical shaped shade member exploded taken at arrow 6 of FIG. 1;

FIG. 7 is a cross-sectional view taken along line 7-7 of FIG. 1 showing the lamp shade disposed between a locking hub and the lamp head; and

FIG. 8 is a perspective view of an alternative base.

### DETAILED DESCRIPTION OF CERTAIN EMBODIMENTS

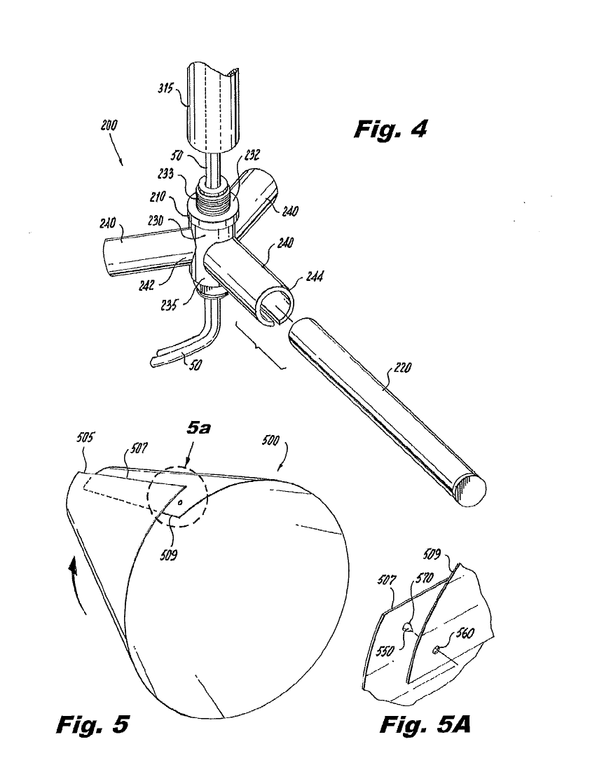

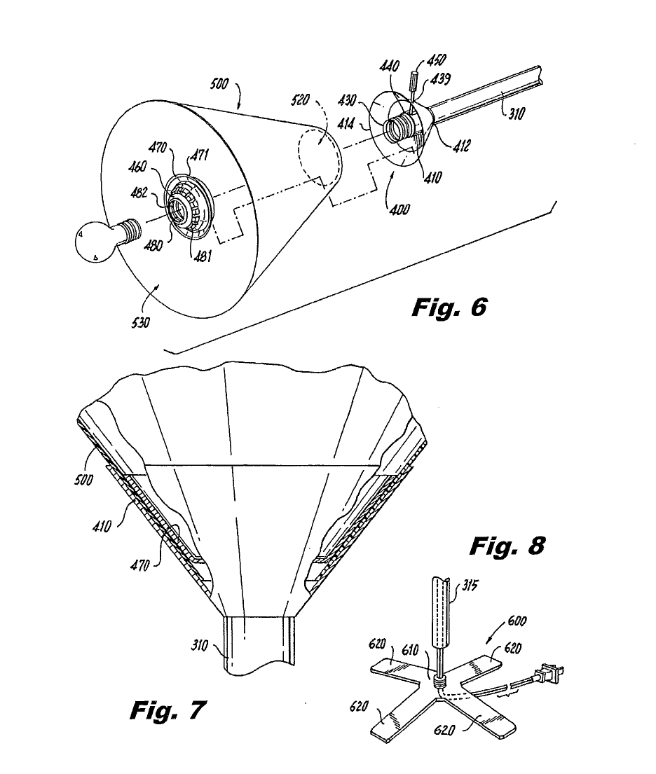

FIGS. 1-8 illustrate a torchiere style lamp 100 having a knock-down profile in accordance with one embodiment of the present invention. The torchiere style lamp 100 is formed of a number of components that are assembled by an end consumer. As discussed herein, the torchiere style lamp 100 is constructed such that it is supplied to the end consumer in a package 10, such as a cardboard carton.

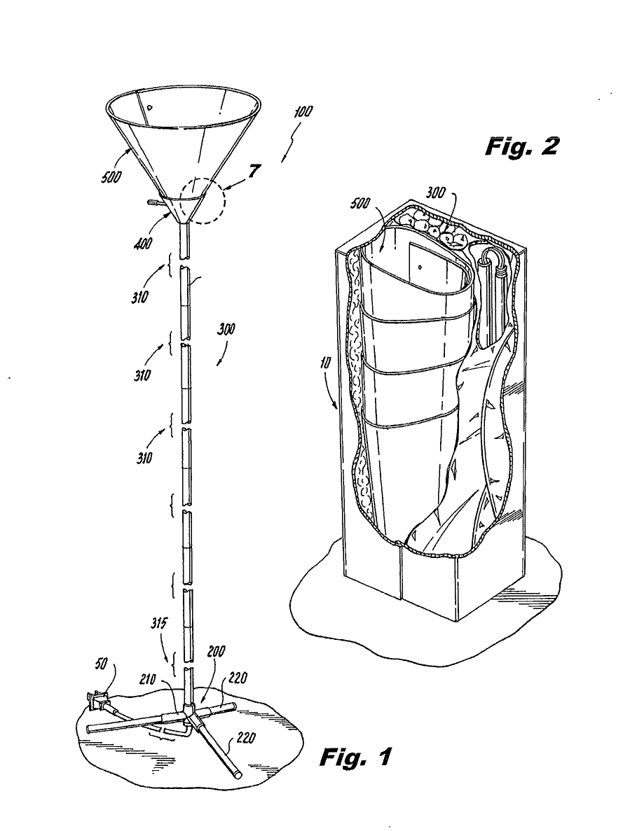

The illustrated torchiere style lamp 100 includes a base assembly 200, a pole or stand assembly 300, a socket 400 and a torchiere shade assembly 500. In accordance with the present invention, all of the individual component and assemblies of the lamp 100 are configured to have a knock-down profile, thereby allowing a minimum amount of packaging (e.g., package 10) to be used as shown in FIG. 2.

The base assembly 200 is formed of a base coupling member 210 that receives and holds a plurality of legs 220 in place. The base coupling member 210 can thus be in the form of a hub from which the legs 220 extend radially outward. The illustrated base coupling member 210 has a tripod shape that is defined by a base tube 230 that has a hollow center (center bore) and three angled tripod legs 240 that extend outwardly from the base tube 230 at an angle. The tripod legs 240 are also hollow structures and in particular, can take the form of split sleeves as shown. It will be appreciated that each of the tripod legs 240 has a first end 242 integrally attached to the base tube 230 and an opposing second end 244.

The base tube 230 thus has a first section 232 that lies above the first ends 242 and a second section 235 that lie below the interface (joint) between the tripod legs 240 and the base tube 230. The first section 232 represents a section of the base assembly 200 that connects to the pole assembly 300 and therefore is constructed to permit secure coupling (attachment) between the base assembly 200 and the pole assembly 300. In the illustrated embodiment, the first section 232 is a threaded tube section in that an outer surface of the base tube 230 includes outer threads 233 in this section. In the event that the base tube 230 is formed of a plastic material, the outer threads 233 can be provided in the form of a metal sleeve that has threads 233 formed therein.

The base 200 is assembled by disposing the legs 220 within the hollow bores of the tripod legs 240 to effectuate a mechanical coupling therebetween. As mentioned, when the tripod legs 240 are in the form of a split sleeves, the legs 240 are thus designed to slidingly accommodate and receive the legs 220. Each leg 220 is an elongated structure (they can be solid or substantially tubular) with a first end that is received within the hollow center of a respective tripod leg 240 and an opposing second end of the leg 220 is a closed end since this end faces the end consumer. The legs 220 are thus press fit into the tripod legs 240 to create the tripod base structure shown in FIG. 1. The second ends of the legs 220 are thus the ground contacting ends on which the base assembly 200 rests. In the fully assembled position, the second section 235 of the base tube 230 is disposed above the ground surface due to the lengths of the legs 220 serving to elevate the base tube 230 from the ground surface. As discussed hereinafter, the elevation of the base tube 230 allows a power cord 50 to be routed therethrough and then directed between the legs 220 to an electric outlet.

It will be understood that the base assembly 200 is only one exemplary type of base that can be used and is of a type that has a knock-down profile to allow minimum product packaging as discussed herein. FIG. 8 shows an alternative base 600 that includes a center coupling member 610 that is configured to attach to the lowermost tube 315. For example, the coupling member 610 can be a male threaded member that mates with a female inner threaded member. The base 600 is an integral structure that includes four legs 620 which can be slightly arched to space the center portion of the base 600 off of the floor to allow the power cord to be routed. The base 600 is thus a single structure that can be disposed within the packaging 10.

It will be understood that the base 200 and base 600 are exemplary bases and the base can include three or more legs and can be formed of a number of parts that mate together or can be formed as a single piece such as shown in FIG. 8.

The torchiere style lamp 100 includes a pole or stand 300 that provides the height to the lamp 100. The pole 300 is formed of a number of parts that are assembled to provide the elongated pole structure shown in FIG. 1. More specifically, the pole 300 is formed of a plurality of first pole sections 310 that have a tubular construction and are open at both first ends 312 and second ends 314 thereof. In the illustrated embodiment, the first pole sections 310 are cylindrically shaped tubular parts that can be formed of any number of different suitable materials, including plastics and metal. Each first pole section 310 is constructed such that the first end 312 includes a first type of fastening structure and the second end 314 includes a second type of fastening structure. For example, the first fastening structure can be in the form of a threaded protrusion 317 and the second fastening structure can be in the form of internal threads 319 formed therein the second end 314 of the first pole section 310. The first pole sections 310 are arranged such that the male fastening feature thereof (threaded protrusion 317) mates with a female fastening feature thereof (internal threads 319). This arrangement allows the first pole sections 310 to be screwed together to construct an elongated tubular structure.

The pole 300 can include a single second pole section 315 that is designed to mate with the first section 232 of the base tube 230 at one end and with a lowermost first pole section 310 at the opposite end. The two ends of the second pole section 315 thus include the same type of fastening feature. For example, as shown, the two ends of the second section 315 include internal threads 319. The internal threads 319 formed at the lowermost end of the second pole section 315 mates with threads 233 of the base tube 230 and the internal threads 319 at the other end mate with the threaded protrusion 317 of the lowermost first pole section 310. This arrangement permits secure coupling of the base 200 to the stand 300.

The socket 400 is formed of a number of parts including parts that mate with the stand 200 and the torchiere shade 500. The socket 400 includes a socket base 410 that has a first end 412 and a second end 414 both of which are at least partially open. The socket base 410 can have a frustoconical or conical shape and is typically formed of a metal material; although other materials can be used.

The socket base 410 has a central opening formed at the first end 412. The first end 412 includes a tubular coupling member 420 to permit the socket base 410 to be attached to the topmost first pole section 310. In particular, the coupling member 420 can be in the form of a threaded protrusion (male fastening member) that mates with the female fastening member 319 of the topmost first pole section 310. In the center of the socket base 410, there is a main socket 430 that is configured to receive a bulb and provide electrical connection thereto. The main socket (housing) 430 can include a coupling section 440 for securely attaching the torchiere shade 500 as discussed herein. The coupling section 440 can be in the form of a threaded ring that surrounds the center electrical socket section 430 that receives and holds the bulb. As shown, the main socket 430 also includes a hole or opening 439 that allows a switch 450 to pass therethrough and be operatively connected to the working electrical components of the main socket 430 to allow the light bulb to be operated. For example, the switch 450 can be in the form of a rotatable stalk that turns power to the lamp 100 on and off and, as mentioned previously, the electronics of the lamp can include a dimmer to allow varying levels of light based on rotation of the stalk 450.

The socket 400 also includes a center hub 460 that is constructed to mate with the coupling section 440 of the main socket 430. As shown, the center hub 460 includes an outer annular shaped part 470 and a center main fastening section 480. The annular shaped part 470 extends radially outward from the main fastening section 480 and has a circumferential outer edge 471. The main fastening section 480 can be in the form of a collar type structure in that it is received around the center socket section 430. The main fastening section 480 has a hollow center and has inner threads 482 formed therein. The inner threads 482 are complementary to and mate with the threads formed on the threaded section 440. When the two parts are attached to one another, a majority of the main fastening section 480 is located above the annular shaped part 470. In the illustrated embodiment, the annular shaped part 470 has a top surface that has a concave shape.

As shown, the top surface (outer periphery) of the main fastening section 480 can have a ribbed surface 481 or the like to assist the end consumer in fastening the hub 460 to the main socket 430 by rotating the hub 460 relative to the main socket 430.

The center hub 460 is configured such that it is received within the concave section of the main socket 430 when the hub 460 mates with the threaded section 440 of the main socket 430. As described below, the center hub 460 substantially fills the main socket 430 when connected thereto; however, a slight peripheral (circumferential) space is formed between the peripheral edge 471 (outer surface) of the part 470 and the inner surface of the main socket 430.

The annular shaped part 470 can be formed of a different material relative to the main fastening section 480. For example, the annular shaped part 470 can be formed of a plastic material, while the main fastening section 480 is formed of a metal.

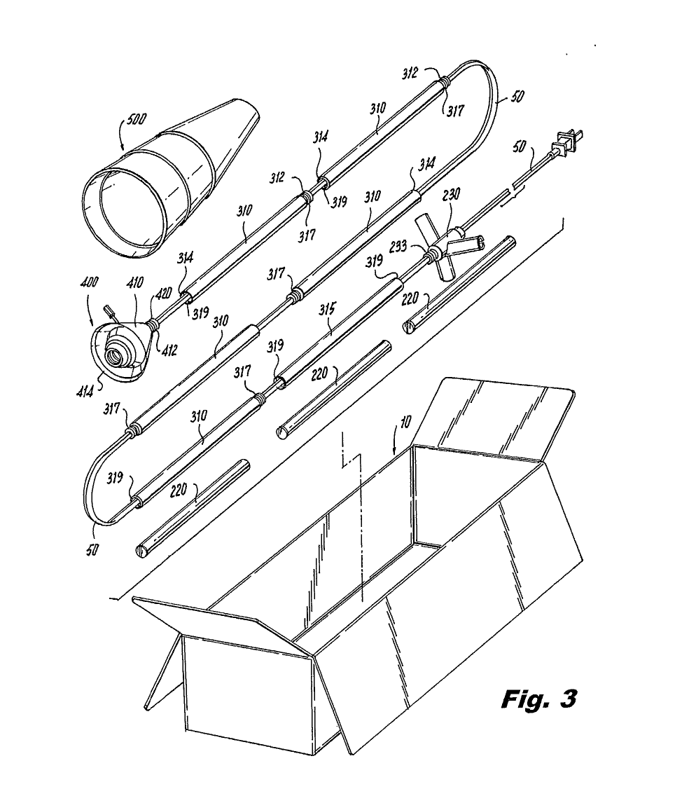

The torchiere shade 500 is in accordance with the present invention configured so as to have a knock-down construction. In particular, the torchiere shade 500 is formed of a flexible material and can therefore be easily manipulated and in the case of the present invention, the torchiere shade 500 can be rolled to allow it to be conveniently disposed within package 10 as shown in FIGS. 2 and 3. The torchiere shade 500 can be formed of a plastic material to allow such rolling. The torchiere shade 500 has a split conical shape in that there is a slit 505 formed in the shade 500 from a bottom edge 502 to a top edge 504 thereof. The slit 505 thus defines a first edge 507 and an opposing second edge 509. The edges 507, 509 extend from the bottom to the top of the shade 500.

The inclusion of the slit 505 in the shade 500 permits the shade 500 to be rolled and this allows the shade 500 to assume a knock-down configuration. More specifically, one edge 507, 509 defines the innermost part of the roll and the shade 500 is rolled to form a circular rolled structure.

When assembled, the shade 500 has a topmost (circular shaped) opening 520 and a bottommost (circular shaped) opening 530. The bottommost opening 530 is smaller than the topmost opening 520. In the assembled position, the shade 500 assumes the classic torchiere shade style and look.

Any number of different techniques can be used to attach the two edges 507, 509 to one another to form the assembled shade 500. For example, mechanical fasteners can be used to attach the two edges 507, 509 to one another to form the assembled frustoconical shape of the shade 500. The mechanical fasteners can include but are not limited to snaps, buttons, pins, rivets or the like, or any other fastener that is able to attach and maintain the two edges 507, 509 in the desired position to form the desired shape completed shade 500. In the illustrated embodiment, the mechanical fasteners are in the form of rivets 550 that are received into corresponding opening 560 formed in the shade. For example, the edge 507 can include a plurality of rivets 550 disposed therealong at spaced intervals. The openings 560 are formed in the shade along the edge 509. It will be appreciated that the edge 507 can include openings 570 that are similar or identical to the openings 560. When the shade 500 is disposed in the assembled position, the openings 560, 570 align with one another and this registration allows the rivets 550 to pass through the at least partially overlapping edges of the shade 500. Each rivet 550 includes an enlarged head that has a size greater than the size of the openings 560, 570, thereby preventing the rivet 550 from passing through the openings 560, 570. A stem or stalk of the rivet 550 represents a modified surface in that along the stem 557 there are means for the attaching and holding the shade edges in the proper orientation, thereby producing the desired frustoconical shape of the shade 500. As shown, the stem can have a tapered construction or can include barbs or the like which providing a gripping member that engages the shade material, thereby locking the shade 500 in place.

The shade 500 is constructed by first unrolling the structure and then placing the openings 560, 570 in registration with one another. Next, the rivets 550 are passed through the aligned openings 560, 570. The stem is constructed such that when the stem is passed through the aligned openings 560, 570, the tapered nature of the stem causes the edges to be held against one another. The construction of the rivets 550 prevents the rivets 550 from freely being removed as by withdrawing the rivets 550 from the openings. When the user inserts the rivets 550 through the openings 560, 570 tactile and/or auditory feedback is provided to alert the end consumer that the overlapping edges 507, 509 are securely attached to one another.

The rivets 550 can be formed of a plastic material and thus have a degree of flexibility. The stem can have a tapered construction with barbs extending radially outward therefrom. The barbs can be formed (angled) such that they can be more easily advanced forward as the rivet 550 is pressed into the overlapping shade edges; however, the bards can provide an interference member that makes it difficult to drive the rivets 550 in the opposite direction and remove them from the overlapping edges. Thus, once assembled, the shade 500 maintains its desired shape.

It will also be appreciated that the shade 500 can have any different shapes than the shape of shade 500 that is shown. The shade 500 is thus not limited to a frusto-conical shape that is shown and instead, the shade 500 can have other shapes so long as the shade 500 can be rolled up (knock-down) as discussed herein and placed in the packaging 10. For example, the shade 500 can have a pyramid type shape with sides that can fold onto themselves to permit the shade 500 to have a knock-down shape.

The assembly of the lamp 100 is now described. First the base 200 is constructed in the manner described above and the legs 220 are disposed within the hollow bores of the tripod legs 240 of the base tube 230 to effectuate a mechanical coupling therebetween. The base 200 can rest on the ground and the power cord 50 can freely extend downwardly and out of the bottom of the base tube 230 to allow subsequent insertion into an electrical outlet.

The single second pole section 315 of the pole 300 mates with the first section 232 of the base tube 230 at one end and mates with a lowermost first pole section 310 at the opposite end. The first pole sections 310 are sequentially mated and secured to one another, thereby constructing the height of the pole 300.

The power cord 50 is routed through the hollow centers of the pole sections 310, 315.

The socket base 410 is attached to the topmost first pole section 310 by mating the tubular coupling member 420 to the female fastening member 319 of the topmost first pole section 310. The center hub 460 is removed from the concave section of the main socket 430. The light bulb socket part is thus freely exposed as well as the threaded section 440 of the main socket 430.

The shade 500 is constructed in the manner described above in that the edges 507, 509 are brought into an overlapping relationship and then the rivets 550 are inserted into the aligned openings 560, 570 to form the conical shaped shade 500.

Once the shade 500 is constructed, the bottom edge of the shade 500 is inserted into the open concave section of the main socket 430. The assembled shade 500 has a shape and dimensions that are complementary to the size and shape of the main socket 430 in that when the shade 500 is inserted into the main socket 430, the outer surface of the assembled shade 500 seats against the inner surface of the main socket 430.

The center hub 460 is then reattached to the main socket 430 by inserting the center hub 460 into the top opening of the assembled shade 500 and lowering the center hub 460 and disposing it around the bulb socket part. The threads of the hub 460 are then mated with the threaded section 440 of the main socket 430. The center hub 460 substantially fills the main socket 430 when connected thereto; however, the shade 500 is disposed in the slight peripheral (circumferential) space formed between the peripheral edge (outer surface) 471 of the part 470 and the inner surface of the socket body 430. In other words, the assembled shade 500 is effectively sandwiched and captured between the hub 460 and the main socket 430. In this position, the shade 500 stands securely upright in the socket assembly 400.

The end consumer then inserts a bulb into the main socket 430 through the open top end of the shade 500. It will be appreciated that the bulb can take any number of different forms and is not limited to a particular type of bulb. For example, the bulb can be an LED bulb, halogen bulb, CFL bulb, incandescent bulb, etc.

It will be appreciated that by constructing all of the major components of the lamp 100 to have a knock-down construction, all of the parts of the lamp 100 can be conveniently packaged in a minimal amount of packing space. This allows the carton 10 or the like that is used to have a small footprint. This reduces not only packaging costs but also yields improvements in storage and transportation since the carton 10 occupies less space and more cartons can be placed on a pallet, etc., more can be placed on a retail shelf, etc.

1. A torchiere style lamp having a knock down profile comprising:
a base;
a pole attached at a bottom end to the base;
a socket assembly attached to a top end of the pole, the socket assembly including a center electrical socket member that is operatively connected to a power cord that is routed through the pole and out of the base and is constructed to receive a bulb;
a torchiere style shade that is removably attached to the socket, the shade being formed of a flexible material and includes a slit formed therein from a bottom edge thereof to a top edge thereof so as to define separate first and second shade edges, wherein in a knock down condition, the shade has a rolled up construction and the shade assumes a fully assembled condition when the first and second edges are joined to one another along the first and second shade edges to form a shade that is open along its top and bottom;
wherein the shade is coupled to the socket assembly by being disposed between a center hub and a main socket part of the socket assembly that surrounds and extends radially outward from the center electrical socket member.

2. The lamp of claim 1, wherein the base includes a center part with hollow fingers extending radially outward therefrom and a plurality of legs that are received within the hollow fingers to establish a frictional mechanical fit therebetween.

3. The lamp of claim 1, wherein the main socket part has a concave shape and is formed of metal with the center electrical socket member being formed above the main socket part.

4. The lamp of claim 1, wherein the center hub includes an outer annular shaped part and a center main fastening section that is disposed around the center electrical socket member.

5. The lamp of claim 4, wherein the outer annular shaped part is formed of a different material relative to the main socket part.

6. The lamp of claim 5, wherein the outer annular shaped part is formed of plastic and the main socket part is formed of metal.

7. The lamp of claim 4, wherein the center main fastening section includes first inner threads which mate with second threads formed on an outer surface of the center electrical socket member for attaching the center hub to the main socket part.

8. The lamp of claim 4, wherein an outer diameter of the outer annular shaped part is less than an inner diameter of the main socket part thereby defining a circumferential peripheral space therebetween, the space having a width that is about equal to or less than a thickness of the shade.

9. The lamp of claim 1, wherein the shade is formed of a plastic material.

10. The lamp of claim 1, wherein the first and second shade edges are attached to one another with fasteners to form the shade.

11. The lamp of claim 10, wherein the first and second shade edges each includes a plurality of spaced openings formed therein, wherein in the fully assembled condition, the openings along the first shade edge are in registration with the openings formed along the second shade edge and the fasteners are received therethrough.

12. The lamp of claim 10, wherein the fasteners comprise rivets.

13. A torchiere style lamp having a knock down profile comprising:
a base;
a pole attached at a bottom end to the base, the pole being formed of a plurality of pole sections that are attached to one another to form the pole;
a socket assembly attached to a top end of the pole, the socket assembly including a center electrical socket member that is operatively connected to a power cord that is routed through the pole and out of the base and is constructed to receive a bulb; and
a torchiere style shade that is removably attached to the socket, the shade being formed of a flexible material and includes a slit formed therein from a bottom edge thereof to a top edge thereof so as to define separate first and second shade edges, wherein in a knock down condition, the shade has a rolled up construction and the shade assumes a fully assembled condition when the first and second edges are joined to one another along the first and second shade edges to form a shade that is open along its top and bottom.

14. The lamp of claim 13, wherein the wherein the shade is coupled to the socket assembly by being disposed between a center hub and a main socket part of the socket assembly that surrounds and extends radially outward from the center electrical socket member.

15. The lamp of claim 13, wherein the base includes a center part that is attached to the pole and a plurality of legs to form a tripod base structure, the legs being removable from the center part.
